(19) United States
(12) Patent Application Publication
(10) Pub. No.: US 2026/0328611 A1
(43) Pub. Date: Oct. 22, 2026

(54) METHOD FOR CONFIGURING A FLOWMETER WITH A MEASURING TUBE THROUGH WHICH A MEDIUM FLOWS

(71) Applicant: KROHNE Messtechnik GmbH, Duisburg (DE)

(72) Inventors: Ali-Osman GEDIKLI, Duisburg (DE); Arthur DEN HAAN, Leiden (NL); Dirk KUSCHNERUS, Krefeld (DE); Christopher LUEKE, Gelsenkirchen (DE); Sven WALBRECKER, Wurster Nordseekueste (DE)

(73) Assignee: KROHNE Messtechnik GmbH, Duisburg (DE)

(21) Appl. No.: 19/655,099

(22) Filed: Apr. 22, 2026

(30) Foreign Application Priority Data
Apr. 22, 2025 (DE) 10 2025 115 410.4

(51) Int. Cl. G01F 25/10; G01F 1/002; G01F 1/58

(52) U.S. Cl. CPC G01F 25/10; G01F 1/002; G01F 1/58

(57) ABSTRACT

A method for configuring a flowmeter. A calibration curve establishes a relationship between the sensor measurement variable and a flow rate of the medium through the measuring tube under defined calibration operating conditions. Increased reliability of the measurement under deviating operating conditions is achieved by specifying operating conditions for the flowmeter in an operating condition step, which deviate at least partially from the defined calibration operating conditions, that in a calibration curve step, a numerical fluid mechanical model of at least the flowmeter is parameterized with the specified operating conditions and is compared with a flow profile calculated on the basis of the parameterized numerical fluid mechanical model. An adapted calibration curve for the specified operating conditions is calculated using a flow profile of the medium calculated on the basis of the parameterized numerical fluid-mechanical model. The adapted calibration curve is stored in the flowmeter.

This nonprovisional application claims priority under 35 U.S.C. § 119(a) to German Patent Application No. 10 2025 115 410.4, which was filed in Germany on Apr. 22, 2025, and which is herein incorporated by reference.

### BACKGROUND OF THE INVENTION

### Field of the Invention

The invention relates to a method for configuring a flowmeter with a measuring tube through which a medium flows, with at least one sensor for capturing a sensor measurement variable dependent on the flow of the medium in the measuring tube and with inlet-side and outlet-side terminals for mounting the flowmeter in a specific installation situation, with a control and evaluation unit, which uses a calibration curve to determine the flow rate of the medium through the measuring tube on the basis of the sensor measurement variable captured by the sensor and provides the determined flow rate as a flow measurement value, wherein the calibration curve establishes a relationship between the sensor measurement variable and the flow rate of the medium through the measuring tube under defined calibration operating conditions.

### Description of the Background Art

The method described for configuring a flowmeter has been practiced for decades, especially when the flowmeter is initially set up at the factory using a calibration stand, where the defined calibration operating conditions mentioned can be ensured. Depending on the type of flow measurement, i.e. the physical measuring principle on which the flow measurement is based, different sensors are used, which provide different sensor measurement variables. In magnetic-inductive flow measurement, the sensor measurement variables are electrode potentials or an electrical electrode differential voltage, from which a flow velocity and thus a volume flow of the medium through the measuring tube can be derived. In Coriolis flow measurement, two measuring tube oscillations are captured by oscillation sensors and a mass flow rate of the medium through the measuring tube is determined from their phase difference. In vortex flow measurement, a medium pressure is captured by a pressure sensor as a sensor measurement variable, the change frequency of which corresponds to a vortex frequency in the medium, from which a medium velocity and thus a volume flow rate of the medium through the measuring tube can be derived. Similar examples could be given for ultrasonic, variable area and temperature flow measurement, etc.

In all the examples given, the calibration curve shows the relationship between the respective sensor measurement variable and the flow rate of the medium through the measuring tube under the defined calibration operating conditions. The calibration curve may have been recorded individually for each device or may also apply to a device type, for example. Usually, several pairs of values of sensor measurement variable and medium flow rate are recorded and a corresponding calibration curve is interpolated by interpolation between the captured values. The calibration curve itself can ultimately be in the form of a table of values or a mathematical description of the curve progression, for example.

If the flowmeter is operated outside the defined calibration operating conditions, the flow measurement values calculated and output on the basis of the calibration curve determined under the defined calibration operating conditions may be erroneous, i.e. also more erroneous than would be expected on the basis of a measurement error determined under calibration operating conditions and specified for the flowmeter.

### SUMMARY OF THE INVENTION

It is therefore an object of the present invention is therefore to further develop a method for configuring a flowmeter in such a way that the flowmeter also works more reliably under operating conditions that deviate from the calibration operating conditions.

In the method described for configuring a flowmeter, the object derived is initially and essentially achieved by specifying operating conditions for the flowmeter in an operating condition step which deviate at least partially from the defined calibration operating conditions. This first determines that and to what extent operating conditions deviating from the calibration operating conditions are present.

Furthermore, it is provided that in a calibration curve step, a numerical fluid mechanical model of at least the flowmeter is parameterized with the specified operating conditions – and thus deviating from the calibration operating conditions – and an adapted calibration curve is calculated for the specified operating conditions using a flow profile of the medium calculated on the basis of the parameterized numerical fluid mechanical model. The adjusted calibration curve is based on the specified operating conditions and is derived numerically, i.e. without the need for renewed measurements in a calibration stand.

Ultimately, the adjusted calibration curve is stored in the flowmeter in such a way that the control and evaluation unit of the flowmeter uses the adjusted calibration curve – instead of the calibration curve originally determined under the defined calibration operating conditions – to determine the flow rate of the medium through the measuring tube. In other words, the adjusted calibration curve becomes the new calibration curve used by the control and evaluation unit.

The method for configuring the flowmeter can be performed several times and repeatedly for a flowmeter, especially if it turns out that the current, specified operating conditions no longer match the operating conditions at which the calibration curve just used was determined.

By configuring the flowmeter as described, the flowmeter is set up in such a way that it can be operated with greater reliability, in the sense of increased accuracy, under the specified calibration operating conditions – and thus deviating from the defined calibration operating conditions. The method for configuring the flowmeter can also be performed during regular operation of the flowmeter, i.e. it can be part of the operation of the flowmeter.

The calibration operating conditions and/or the specified operating conditions can be properties of the medium, as they often have a direct influence on the flow of the medium through the flowmeter, i.e. they lead to a changed relationship between the sensor measurement variable and the flow of the medium through the measuring tube. In particular, the properties of the medium are at least one of the following properties: the temperature, the viscosity, the density of the medium, the pressure in the medium, information regarding the phases of the medium (multiphase information), a particle concentration in the medium, the particle size of particles in the medium, the gas volume fraction in the medium and/or the flow rate of the medium through the measuring tube. The flow rate of the medium through the measuring tube is interesting, for example, because the flow velocity that can be determined in this way, which, in addition to the dynamic viscosity and the density of the medium, is included in the Reynolds number, is decisive for the type of flow that occurs (laminar, turbulent).

In order for these variables to be taken into account when calculating the adjusted calibration curve, the numerical fluid mechanical model must also take these properties into account when calculating the flow profile. The possibility of taking these properties into account results due to the circumstance that the numerical fluid mechanical model is parameterized with the above-specified operating conditions – and thus with the specified properties of the medium – including the Reynold’s number or a selection of these parameters.

The operating conditions can be properties of the installation situation in the direction of flow upstream of the inlet-side terminal and/or downstream of the outlet-side terminal of the flowmeter. These properties of the installation situation of the flowmeter include, in particular, at least one of the following properties due to the installation situation: bends, branches, diameter changes, valves, fixtures, other flowmeters, (half) shut-off valves or swirl generators (which are mostly used for testing and verification purposes). So that the properties of the installation situation of the flowmeter upstream and downstream of the flowmeter itself can be taken into account, the numerical fluid mechanical model has corresponding extensions that take the specifications of these properties into account in terms of flow technology when calculating the flow profile of the medium. Consideration of the installation situation takes into account that in order to achieve a flow profile that is as undisturbed as possible, ideally under calibration conditions, the inlet section must be as long and straight as possible and the outlet section not too short and straight, and there must be no upstream flow fittings that could also distort the flow profile. If these boundary conditions are not present, their influence is taken into account in accordance with the described process variation.

The numerical fluid mechanical model of the flowmeter can be checked using original defined calibration operating conditions. By original defined calibration operating conditions, what is actually meant is the calibration operating conditions under which the flowmeter was first calibrated at the factory, for example, with water, at room temperature, at a minimum to a maximum flow velocity, with undisturbed inlet and outlet sections. These are therefore reliable and accurate specifications of operating conditions. During the check, the numerical fluid mechanical model is parameterized with the original defined calibration operating conditions. A calibration curve difference is then determined between an original calibration curve captured measurement-based at original calibration operating conditions (i.e. the calibration curve determined at the factory) and a calibration curve calculated by the numerical fluid mechanical model parameterized with the original defined calibration operating conditions. Preferably, the numerical flow model (flow physics equations) and/or the simulation boundary conditions (e.g. geometric parametrization of the flow volume for the numerical calculation) are adjusted and made more precise until the calibration curve difference is smaller than a specified calibration curve difference limit. This ensures that the numerical flow model meets the desired accuracy requirements.

This further development of the method can be an upstream step for improving the numerical fluid mechanical model before the model is parameterized with deviating operating conditions and used to calculate adapted calibration curves.

The calibration curve step can be performed on a service computer that is different from the flowmeter and the adjusted calibration curve determined on the service computer is transferred to the flowmeter, preferably via a data connection between the service computer and the flowmeter or by means of a control unit that is connected to the flowmeter via a control unit interface. This procedure has proven to be particularly advantageous for extensive numerical fluid mechanical models, the calculation of which is not reasonably possible on conventional flowmeters, whose hardware equipment is usually designed in such a way that the central measurement task can be performed, but beyond that there is hardly any computing capacity. Since flowmeters are usually also connected to higher-level control computers via a fieldbus, the described procedure is possible in most cases.

The flowmeter can be a magnetic-inductive flowmeter. The magnetic-inductive flowmeter comprises at least one magnetic field generating device for generating a magnetic field permeating the measuring tube in a measuring region perpendicular to the direction of flow of the medium and at least one pair of measuring electrodes as a sensor in the measuring region of the measuring tube for tapping an electrical voltage induced in the medium in the measuring tube as a sensor measurement variable. The control and evaluation unit uses the calibration curve, which assigns a flow measurement value to the induced electrical voltage, to determine the volumetric flow rate of the medium through the measuring tube. If necessary, the electrical flux density present at the measuring electrodes is also taken into account.

The magnetic field generated by the magnetic field generating device can be determined with spatial resolution when the method is used with a magnetic-inductive flowmeter. The numerical fluid mechanical model is used to calculate the flow profile of the medium through the measuring region of the measuring tube. A mathematical electrodynamic model is used to determine the induced electrical voltage between the measuring electrodes of the measuring electrode pair from the flow profile of the medium in the measuring region of the measuring tube and from the determined magnetic field in the measuring region of the measuring tube as well as with the properties of the medium in the measuring tube under the specified operating conditions.

In the electrodynamic model, the electrode voltage can be calculated using a volume integral over the interior of the magnetic-inductive flowmeter; the integrand is the scalar product of a so-called weight function and the velocity field of the flow. In particular, the determined distribution of the magnetic field is included in the weight function. This takes into account that different flow elements contribute to the measuring voltage in different ways in the volume of the magnetic-inductive flowmeter.

In this way, the adapted calibration curve for the specified operating conditions can be determined, which establishes a relationship between the electrical voltage induced in the medium between the measuring electrodes of the measuring electrode pair as the sensor measurement variable and the flow rate of the medium through the measuring tube for the specified operating conditions.

The magnetic field generated by the magnetic field generating device in the measuring region of the measuring tube can be calculated spatially resolved using a numerical electrodynamic model and/or is determined spatially resolved measurement-based by measuring a plurality of magnetic field strengths in the measuring region of the measuring tube. It has been found to be particularly advantageous if the magnetic field distribution calculated with the numerical electrodynamic model is compared with the magnetic field distribution determined by measurement and the numerical electrodynamic model is adapted and made more precise until a magnetic field distribution difference is smaller than a predetermined magnetic field difference limit.

The method for configuring a flowmeter, which was initially described above in general terms without any specific reference to a determined flow measurement method, and which was then described with regard to magnetic-inductive flowmeters, is of course also applicable to flowmeters which operate on the basis of other flow measurement methods, for example on the basis of the flow measurement methods which were mentioned at the beginning. The numerical fluid mechanical model used in the calibration curve step must be able to establish the necessary relationship between the sensor measurement variable occurring in the respective measuring method and the flow rate of the medium through the measuring tube, taking into account the specified operating conditions that deviate from the defined calibration operating conditions. A corresponding adapted calibration curve can then be calculated for each flow measurement method and each flowmeter in question and used in the respective flowmeter.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically, a flowmeter known from the state of the art with a control and evaluation unit and a calibration curve for determining a flow measurement value,

FIG. 2 schematically, a method for configuring a flowmeter using a numerical fluid mechanical model,

FIG. 3 schematically, a method for configuring a flowmeter using a numerical fluid mechanical model, taking into account the installation situation of the flowmeter,

FIG. 4 schematically, a method for configuring a flowmeter using a numerical fluid mechanical model, wherein the numerical fluid mechanical model is improved using original calibration operating conditions, and

FIG. 5 schematically, a method for configuring a flowmeter using a numerical fluid mechanical model and a mathematical electrodynamic model.

### DETAILED DESCRIPTION

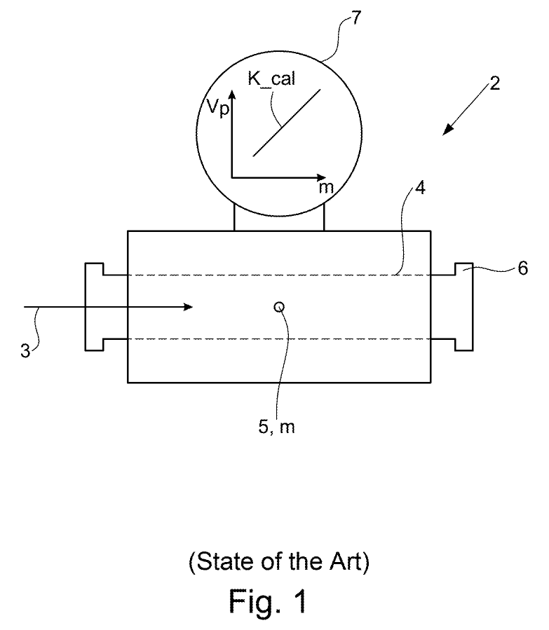

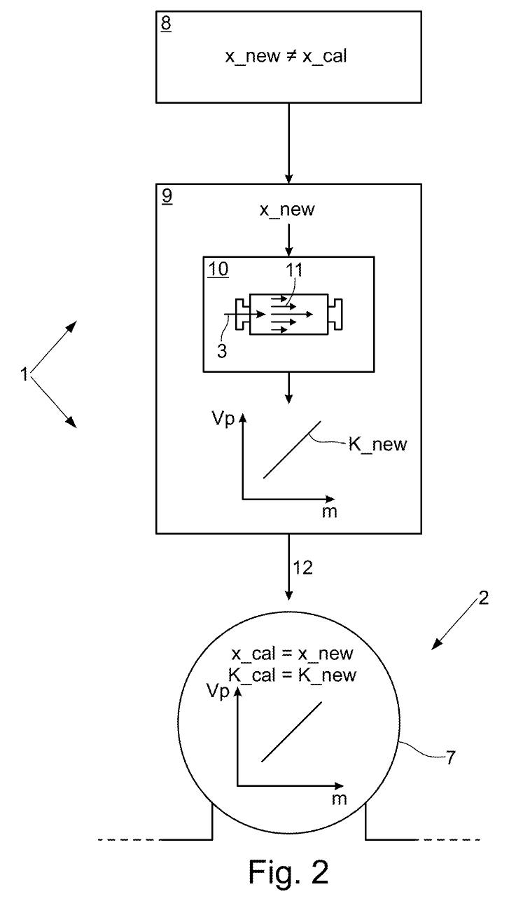

FIGS. 2-5 show various aspects of a method 1 for configuring a flowmeter 2. FIG. 1 shows a flowmeter 2 with various features that the flowmeter 2 must have as a prerequisite so that the method 1 for configuring the flowmeter 2 can also be performed sensibly.

The flowmeter 2 comprises a measuring tube 4 through which a medium 3 flows, at least one sensor 5 for capturing a sensor measurement variable m that is dependent on the flow of the medium 3 in the measuring tube 4 and terminals 6 on the inlet and outlet sides for mounting the flowmeter 2 in a specific installation situation, for example in a larger process engineering system, which is not shown further in FIG. 1.

The flowmeter 2 also comprises a control and evaluation unit 7, symbolized by the indicated transmitter head, which uses a calibration curve K_cal to determine the flow rate Vp of the medium 3 through the measuring tube 4 based on the sensor measurement variable m captured by the sensor 5 and provides the determined flow rate Vp as a flow measurement value. The calibration curve K_cal establishes a relationship between the sensor measurement variable m and the flow rate Vp of the medium 3 through the measuring tube 4 at defined calibration operating conditions x_cal. In practice, the calibration curve K_cal is often only described by a single device constant; the device constant then represents the entire measuring region and is to be regarded as the slope of the calibration curve K_cal.

The relationship between the sensor measurement variable m and the flow rate Vp of the medium 3 applies when the defined calibration operating conditions x_cal are present, for example at a determined temperature and viscosity of the medium 3. If the actual operating conditions deviate from the defined calibration operating conditions x_cal, the calibration curve K_cal is not suitable for deriving the flow rate Vp from the sensor measurement variable m, or only to a very limited extent (measurement error).

This is where the method 1 shown in FIGS. 2-5 comes into play, with which the flowmeter 2 is configured in such a way that a more reliable, i.e. more accurate, operation of the flowmeter 2 is achieved even under operating conditions that deviate from the defined calibration operating conditions x_cal.

As can be seen in FIG. 2, the method 1 provides that in an operating condition step 8, operating conditions x_new are specified for the flowmeter 2 that deviate at least partially from the defined calibration operating conditions x_cal. The operating conditions x_new can generally be captured in different ways, for example they can be captured by the flowmeter 2 itself. For example, some flowmeters 2 are able to determine the temperature, viscosity, density of the medium 3 or its gas volume fraction (for example Coriolis mass flowmeters). However, the operating conditions can also be captured at other points and collected and indicated by a master computer, for example. The method of collecting and providing the operating conditions x_new, which deviate from the defined calibration operating conditions x_cal, is not important for the method 1; what is important is that the operating conditions x_new – however determined – are specified.

In a calibration curve step 9, a numerical fluid mechanical model 10, often referred to as a CFD model (computational fluid dynamics), of at least the flowmeter 2 is parameterized with the specified operating conditions x_new. The parameterized numerical fluid mechanical model 10 is used to calculate a flow profile 11 of the medium 3 and an adapted calibration curve K_new for the specified operating conditions x_new is calculated from the calculated flow profile 11 of the medium. In order to obtain an adapted calibration curve K_new, the flow profile 11 is calculated for several flow rates Vp in the flow measurement range of interest. The flow profile 11 is then used to determine the sensor measurement variable m, which in the case of a flowmeter 2 depends on the flow rate Vp of the medium 3 and thus on the flow profile 11 of the medium 3. It is possible that numerical model extensions must be used in addition to the numerical fluid mechanical model 10 in order to be able to determine the sensor measurement variable m from the flow profile 11 as part of a simulation.

The adapted calibration curve K_new is then stored 12 in the flowmeter 2 in such a way that the control and evaluation unit 7 of the flowmeter 2 uses the adapted calibration curve K_new as the calibration curve K_cal to determine the flow rate of the medium 3 through the measuring tube 4. The adjusted calibration curve K_new thus becomes the current calibration curve K_cal in the control and evaluation unit 7 and the specified operating conditions x_new become the defined calibration operating conditions x_cal.

In the examples shown, the calibration operating conditions x_cal and the specified operating conditions x_new are – in any case also – properties of the medium 3, in this case the temperature, viscosity and density of the medium 3 as well as the flow rate of the medium 3.

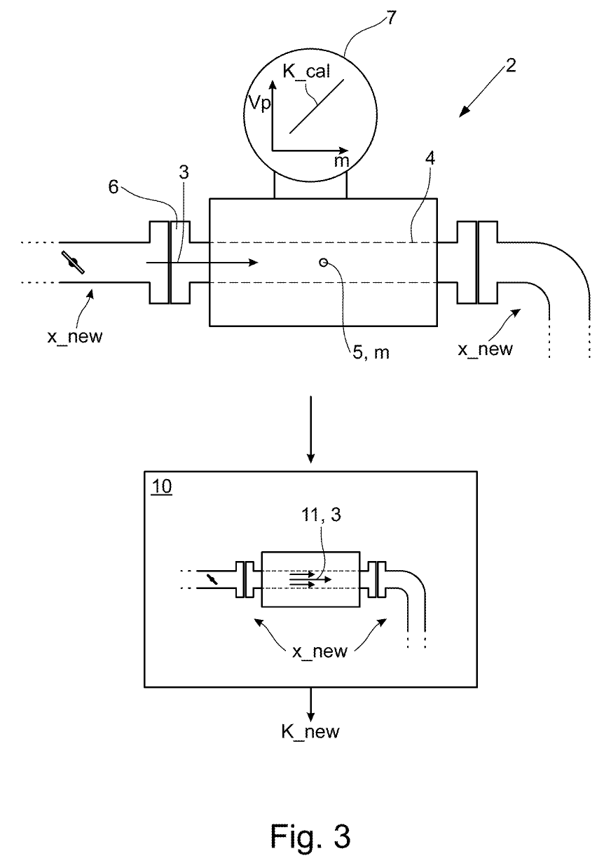

FIG. 3 shows that the defined calibration operating conditions x_cal and the specified operating conditions x_new are also properties of the installation situation in the flow direction upstream of the inlet-side terminal 6 and downstream of the outlet-side terminal 6 of the flowmeter 2. The defined calibration operating conditions x_cal include a straight inlet section up to a certain distance upstream of the inlet-side terminal 6 and a straight outlet section up to a certain distance downstream of the outlet-side terminal 6. Both conditions are not fulfilled in the installation situation shown in FIG. 3. The numerical fluid mechanical model 10 has corresponding model extensions with which the valve on the inlet side and the curvature on the outlet side are taken into account, so that these influences are also taken into account when determining the adapted calibration curve K_new on the basis of the numerical fluid mechanical model 10. The method 1 has considerable advantages, as adapted calibration curves K_new can be determined for practically all specified operating conditions x_new, even without removing the flowmeter 2 from its installation situation.

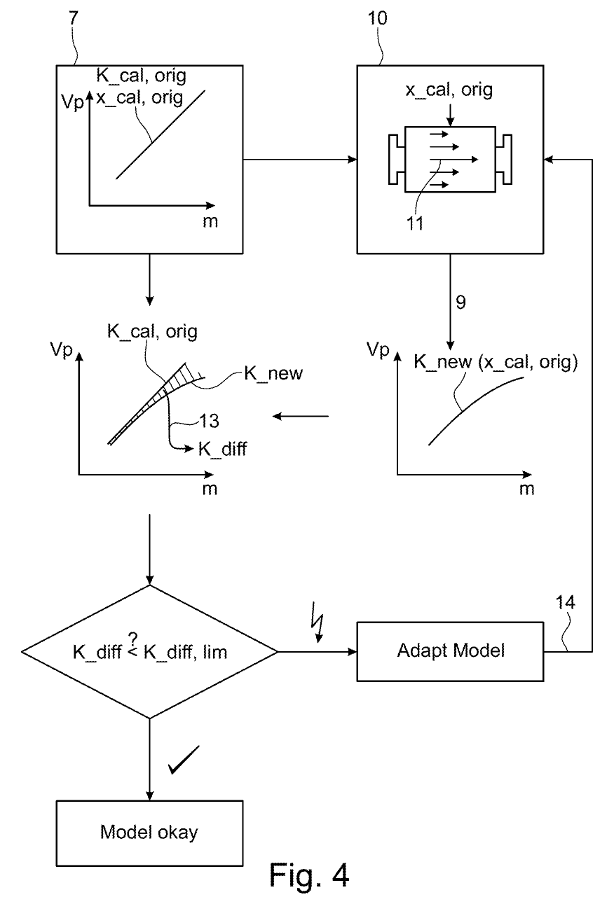

FIG. 4 shows a further development of method 1, in which the numerical fluid mechanical model 10 of the flowmeter 2 is checked using original defined calibration operating conditions x_cal,orig. Original defined calibration operating conditions x_cal,orig are the calibration operating conditions at which the flowmeter has been calibrated at the factory. It is therefore highly probable that the original calibration curve K_cal,orig, which was captured measurement-based, was actually based on these operating conditions with a high degree of accuracy.

The fluid mechanical model 10 of the flowmeter 2 is checked using the original defined calibration operating conditions x_cal,orig by parameterizing the numerical fluid mechanical model 10 with the original defined calibration operating conditions x_cal,orig and calculating the adjusted calibration curve K_new on this basis using the parameterized numerical fluid mechanical model 10 (in FIG. 4 the partial figure in the second line on the right).

A calibration curve difference K_diff is then determined 13 (in FIG. 4 the partial figure in the second line on the left) between the calibration curve K_cal,orig captured measurement-based at the original calibration operating conditions x_cal,orig and the calibration curve K_new calculated by the numerical fluidic model 10 parameterized with the original defined calibration operating conditions x_cal,orig. In the example, the area between the two calibration curves is calculated as the calibration curve difference K_diff.

The numerical fluidic model 10 and the simulation boundary conditions are adapted 14 and made more precise (“adapt model”) until the calibration curve difference K_diff is smaller than a predetermined calibration curve difference limit K_diff,lim. If the calibration curve difference K_diff is smaller than the predetermined calibration curve difference limit K_diff,lim (“Model okay”), the numerical fluidic model 10 is used to perform method 1. This is therefore a preparatory method step which can be used to ensure that the numerical fluid dynamics model 10 used meets the desired quality requirements.

In the method 1 shown in the figures, the calibration curve step 9 is performed on a service computer that is different from the flowmeter 2, and the adjusted calibration curve K_new determined on the service computer is transferred from the service computer – not shown – to the flowmeter 2.

The method 1 described can be implemented regardless of the type of flowmeter 2 and the measuring principle implemented there.

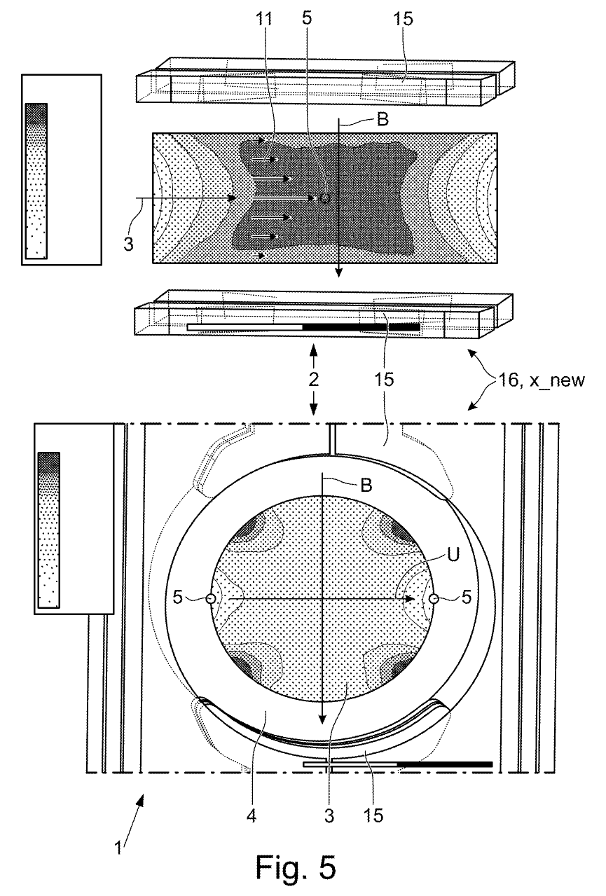

In the flowmeters shown in FIGS. 3 and 5, the flowmeter 2 is a magnetic-inductive flowmeter with a magnetic field generating device 15 for generating a magnetic field B permeating the measuring tube 4 in a measuring region perpendicular to the direction of flow of the medium 3, with at least one pair of measuring electrodes as a measuring sensor 5 in the measuring region of the measuring tube 4 for tapping an electrical voltage U induced in the medium 3 in the measuring tube 4 as a sensor measurement variable m, wherein the control and evaluation unit 7 assigns a flow measurement value Vp to the induced electrical voltage U by means of the calibration curve K_cal and thus determines the volume flow of the medium 3 through the measuring tube 4.

In a magnetic-inductive flowmeter, the medium 3 must have a certain electrical conductivity. The charge carriers causing the conductivity, which move with the medium through the magnetic field, experience a force in the magnetic field which, depending on the flow velocity, performs a charge separation and thus leads to an electrical potential difference – the induced voltage – in the medium, which is recorded as the sensor measurement variable m via the measuring electrode pair. The magnetic-inductive flowmeter therefore combines fluidic and electrodynamic variables.

As shown in FIG. 5, the magnetic field B generated by the magnetic field generating device 15 is determined with spatial resolution. For the specified operating conditions x_new, the numerical fluid mechanical model 10 is used to calculate the flow profile 11 of the medium 3 through the measuring region of the measuring tube 4. A mathematical electrodynamic model 16 is used to determine the induced electrical voltage U between the pairs of measuring electrodes from the flow profile 11 of the medium 3 in the measuring region of the measuring tube 4 and from the determined magnetic field B in the measuring region of the measuring tube 4 as well as with the properties of the medium 3 in the measuring tube 4 under the specified operating conditions x_new.

In this way, the adapted calibration curve K_new is determined for the specified operating conditions x_new, which establishes a relationship between the electrical voltage U induced in the medium 3 between the measuring electrodes of the pair of measuring electrodes as sensor measurement variable m and the flow rate Vp of the medium 3 through the measuring tube 4 for the specified operating conditions x_new.

In the method variation 1 shown in FIG. 5, the magnetic field B generated by the magnetic field generator 15 in the measuring region of the measuring tube 4 is calculated with spatial resolution using a numerical electrodynamic model 16. In a likewise practiced method variation 1, which is not shown in detail, the magnetic field B in the measuring region of the measuring tube 4 is determined in a spatially resolved measurement-based manner by measuring a plurality of magnetic field strengths. To ensure the quality of the magnetic field distribution calculated with the numerical electrodynamic model 16, it is compared with a magnetic field distribution determined by measurement. The numerical electrodynamic model 16 is adapted and made more precise until a predetermined magnetic field distribution difference is smaller than a predetermined magnetic field difference limit. This procedure is similar to the procedure for ensuring the quality of the numerical fluid mechanical model 10.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method to configure a flowmeter with a measuring tube through which a medium flows, with at least one measuring sensor for detecting a sensor measurement variable dependent on the flow of the medium in the measuring tube, with inlet-side and outlet-side terminals for mounting the flowmeter in a specific installation situation, with a control and evaluation unit which, using a calibration curve, based on the sensor measurement variable detected by the sensor, draws conclusions about the flow of the medium through the measuring tube and provides the determined flow rate as a flow measurement value, the calibration curve establishing a relationship between the sensor measurement variable and the flow rate of the medium through the measuring tube under defined calibration operating conditions, the method comprising:
specifying, in an operating-condition step for the flowmeter, operating conditions that at least partially differ from the defined calibration operating conditions;
parameterizing, in a calibration curve step, a numerical fluid-mechanical model of at least the flowmeter with the specified operating conditions;
calculating an adapted calibration curve for the specified operating conditions using a flow profile of the medium based on the parameterized numerical fluid-mechanical model; and
storing the adapted calibration curve in the flowmeter such that the control and evaluation unit of the flowmeter uses the adapted calibration curve to determine the flow of the medium through the measuring tube.

2. The method according to claim 1, wherein the calibration operating conditions and/or the specified operating conditions are properties of the medium or are temperature, viscosity, density, pressure, multiphase information, particle concentration, particle size, or a gas volume fraction.

3. The method according to claim 1, wherein the operating conditions and/or the specified operating conditions are properties of the installation situation in the direction of flow in front of the inlet-side terminal and/or behind the outlet-side terminal of the flowmeter or bends, branches, diameter changes, valves, or built-in components, and wherein the installation situation on the inlet side and/or outlet side is taken into account by corresponding extension of the numerical fluid-mechanical model.

4. The method according to claim 1, wherein the numerical fluid-mechanical model of the flowmeter is checked on the basis of the original defined calibration operating conditions by parameterizing the numerical fluid-mechanical model with the original defined calibration operating conditions and determining a calibration curve difference between an original calibration curve determined under original calibration operating conditions on the basis of measurement-based capture and a calibration curve calculated by the numerical fluid-mechanical model parameterized with the original defined calibration operating conditions, and wherein the numerical fluid-mechanical model and/or the simulation boundary conditions are adapted and specified until the calibration curve difference is smaller than a predetermined calibration curve difference limit.

5. The method according to claim 1, wherein the calibration curve step is carried out on a service computer that is different from the flowmeter, and wherein the adjusted calibration curve determined on the service computer is transferred to the flowmeter via a data connection between the service computer and the flowmeter or via a control unit that is connected to the flowmeter via a control unit interface.

6. The method according to claim 1, wherein the flowmeter is a magnetic-inductive flowmeter with at least one magnetic field generating device for generating a magnetic field permeating the measuring tube in a measuring region substantially perpendicular to the flow direction of the medium, with at least one pair of measuring electrodes as a measurement sensor in the measuring region of the measuring tube for tapping an electrical voltage induced in the medium in the measuring tube as a sensor measurement variable, and wherein the control and evaluation unit assigns a flow measurement value to the induced electrical voltage via the calibration curve and thus determines the volumetric flow rate of the medium through the measuring tube.

7. The method according to claim 6, wherein the magnetic field generated by the magnetic field generating device is determined with spatial resolution, in that the flow profile of the medium through the measuring region of the measuring tube is calculated for the specified operating conditions using the numerical fluid-mechanical model, and in that a mathematical electrodynamic model is used to calculate the magnetic field from the flow profile of the medium in the measuring region of the measuring tube and from the determined magnetic field in the measuring region of the measuring tube and with the properties of the medium in the measuring tube under the specified operating conditions, the induced electrical voltage between the measuring electrodes of the pair of measuring electrodes is determined and thus the adapted calibration curve for the specified operating conditions is determined, which establishes a relationship between the electrical voltage induced in the medium between the measuring electrodes of the measuring electrode pair as transducer measured variable and the flow rate of the medium through the measuring tube for the specified operating conditions.

8. The method according to claim 7, wherein the magnetic field generated by the magnetic field generator in the measuring region of the measuring tube is calculated in a spatially resolved manner with the aid of a mathematical electrodynamic model and/or is determined in a spatially resolved manner by measurement of a plurality of magnetic field strengths in the measuring region of the measuring tube, or wherein the magnetic field distribution calculated by the mathematical electrodynamic model is compared with the magnetic field distribution determined by measurement and the mathematical electrodynamic model is adapted and specified such that a magnetic field distribution difference is smaller than a specified magnetic field difference limit.
